(19) United States
(12) Patent Application Publication
(10) Pub. No.: US 2013/0304588 A1
(43) Pub. Date: Nov. 14, 2013

(54) PAY-PER-CHECK IN ADVERTISING

(71) Applicant: Lalin Michael Jinasena, Colombo (LK)

(72) Inventor: Lalin Michael Jinasena, Colombo (LK)

(21) Appl. No.: 13/826,864

(22) Filed: Mar. 14, 2013

Related U.S. Application Data
(60) Provisional application No. 61/645,029, filed on May 9, 2012.
(60) Provisional application No. 61/667,731, filed on Jul. 3, 2012.

(51) Int. Cl. G06Q 30/02

(52) U.S. Cl. CPC G06Q 30/0273
USPC 705/14.69

(57) ABSTRACT

A computerized advertising system may include an input communication system configured to receive information indicative of one or more ads, each for a product or service marketed by a merchant. An ad database storage system may be configured to store information indicative of the ads. A computerized ad circulation system may be configured to controllably cause the ads to be delivered to recipients. A computerized merchant check-in tracking system may be configured to receive check-in information indicative of when each recipient visits each merchant. A computerized merchant billing system may be configured to bill the merchant of each ad based on the number of recipients of the ad that visit the merchant.

### CROSS-REFERENCE TO RELATED APPLICATIONS

This application is based upon and claims priority to U.S. provisional patent application No. 61/645,029, entitled “METHOD AND SYSTEM FOR LIFESTYLE MEDIA NETWORK,” filed May 9, 2012, attorney docket number 087895-0013; and U.S. provisional patent application No. 61/667,731, entitled “MARKETING SYSTEM UTILIZING VIRTUAL STORES AND TARGETED ADS,” filed Jul. 3, 2012, attorney docket number 087895-0052; The entire content of each of these applications is incorporated herein by reference.

### BACKGROUND

1. Technical Field

This disclosure relates to computerized advertising systems.

2. Description of Related Art

Computerized advertising systems commonly circulate advertisements by a variety of methods, such as by email, regular mail, telephone, web postings, and/or instant messages.

The effectiveness of such ads, however, can be hard to judge. As a consequence, merchants may be hesitant to spend much to have their ads circulated by such systems.

One approach to dealing with this concern may be to bill a merchant only for those ads that result in a sale of the advertised product. However, such sales can be hard to track, particularly when they take place at a merchant's brick and mortar store. Further, an ad may lead to a customer purchasing a product different from the one advertised, yielding great value to the merchant, but no payment to the advertiser.

### SUMMARY

A computerized advertising system may include an input communication system configured to receive information indicative of one or more ads, each for a product or service marketed by a merchant. An ad database storage system may be configured to store information indicative of the ads. A computerized ad circulation system may be configured to controllably cause the ads to be delivered to recipients. A computerized merchant check-in tracking system may be configured to receive check-in information indicative of when each recipient visits each merchant. A computerized merchant billing system may be configured to bill the merchant of each ad based on the number of recipients of the ad that visit the merchant.

The computerized merchant billing system may be configured not to increase the amount that is billed for each ad after the number of recipients of the ad that visit the merchant of the ad exceeds a threshold.

The input communication system may be configured to receive the threshold for each ad. The input communication system may be configured to restrict the value of each threshold that the input communication system is configured to receive. The ad database storage system may be configured to store each received threshold.

The computerized advertising system may include a computerized check-in estimation system configured to estimate for each ad how long it will take for the threshold number of recipients of the ad to visit the merchant of the ad based on the threshold for each ad, the number of recipients of the ad, and/or historical data indicative of how long it took a threshold number of recipients of one or more other ads to visit the merchants of those other ads.

A first of the merchants may have a store in a first geographic region. A second of the merchants may have a store in a second geographic region that is different from the first geographic region. The computerized check-in estimation system may be configured to estimate how long it will take to reach the threshold for an ad for the first merchant's store based on historical data indicative of how long it took to reach the respective thresholds for other ads for stores in the first region. The computerized check-in estimation system may be configured to estimate how long it will take to reach the threshold for an ad for the second merchant's store based on historical data indicative of how long it took to reach the respective thresholds for other ads for stores in the second region.

The computerized merchant billing system may be configured for each ad not to increase the amount that is billed to the merchant of that ad when a recipient of the ad visits the merchant more than once. For example, the computerized merchant billing system may be configured for each ad not to increase the amount that is billed to the merchant of that ad when a recipient of the ad visits the merchant more than once within a pre-determined period, but to increase the amount that is billed to the merchant of that ad when the recipient of the ad visits the merchant both within and after the pre-determined period. The pre-determined period may be 24 hours.

The computerized merchant billing system may be configured for each ad not to bill the merchant of that ad based on the number of recipients of that ad that do not visit the merchant of the ad.

The computerized merchant billing system may be configured for each ad to bill the merchant of the ad in an amount that does not depend upon whether any recipient of the ad makes any purchase from that merchant.

The input communication system may be configured to receive circulation information indicative of a class of recipients to whom each ad is to be delivered. The ad database storage system may be configured to store the circulation information. The computerized ad circulation system may be configured to cause each ad to be delivered to the class of recipients indicated by its circulation information.

The computerized merchant check-in tracking system may be configured to receive the check-in information from a wireless mobile device that is carried by each recipient.

The check-in information may include reports of the geographic coordinates of each wireless mobile device. The computerized merchant check-in tracking system may be configured to determine whether each recipient has visited a merchant by comparing the geographic coordinates with known geographic coordinates of each merchant.

The check-in information may include a code that each wireless mobile communication device receives from a short range code transmitter at a merchant store. The computerized merchant check-in tracking system may be configured to determine whether each recipient has visited a merchant by comparing each received code with a known code for each merchant.

The input communication system may be configured to receive delivery information indicative of when each ad should be delivered. The ad database storage system may be configured to store the delivery information. The computerized ad circulation system may be configured to cause each ad to be delivered to recipients in accordance with the delivery information.

The computerized merchant billing system may be configured for each ad to bill each merchant of the ad a fix fee for each recipient that receives the ad and visits the merchant of the ad. The amount of the fix fee for each ad may be based on the size of that ad and/or the geographic area in which the recipients of that ad are located.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a network communication system that include a computerized advertising system, multiple ad recipient mobile devices, and multiple merchant computer systems.

FIG. 2 illustrates an example of a computerized advertising system.

FIG. 3 illustrates an example of an ad recipient mobile device that includes a check-in application and a wireless mobile communication system.

FIG. 4 illustrates an example of an ad recipient mobile device that includes a location detection system and a wireless mobile communication system.

FIG. 5 illustrates an example of an ad recipient mobile device that includes a short range merchant code receiver and a wireless mobile communication system.

FIG. 6 illustrates an example of a merchant store that includes a short range merchant code transmitter.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

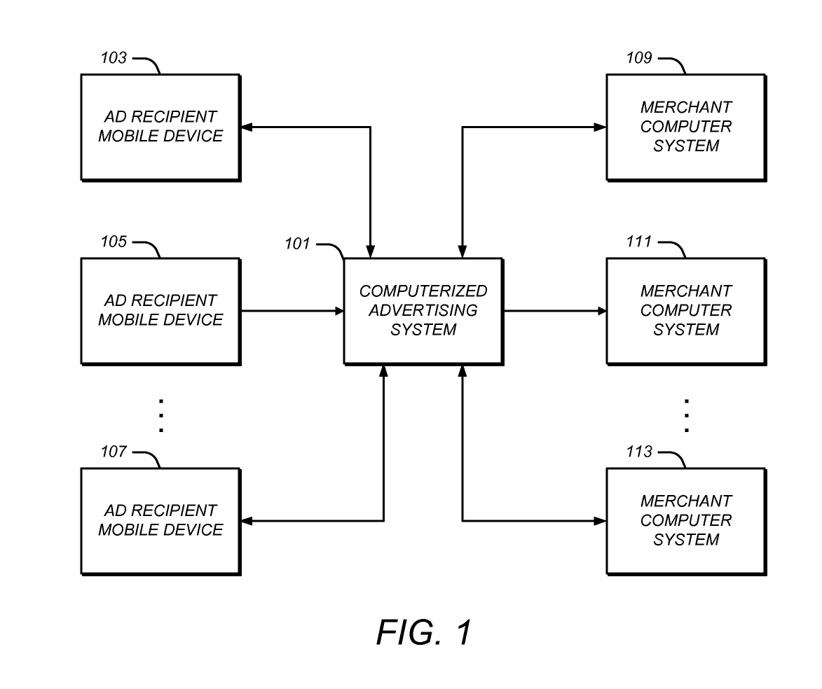

FIG. 1 illustrates an example of a network communication system that include a computerized advertising system 101, multiple ad recipient mobile devices 103, 105, and 107, and multiple merchant computer systems 109, 111, and 113.

Each merchant computer system may be configured to direct the computerized advertising system 101 to deliver one or more ads to one or more ad recipients, such as to the ad recipient mobile devices 103, 105, and/or 107. Each ad may be for a product or service marketed by a merchant that is associated with the merchant computer system. Each merchant computer system may be configured to deliver the ad that is to be circulated to the computerized advertising system 101 and/or to select the ad and/or components of the ad from the computerized advertising system 101.

The computerized advertising system 101 may be configured to deliver one or more of these ads to recipients, such as to the ad recipient mobile devices 103, 105, and 107. Each ad recipient mobile device may be configured to receive each ad that is delivered to it by the computerized advertising system 101 and to display it to a user of the ad recipient mobile device.

The computerized advertising system 101 may be configured to receive information indicative of when each ad recipient visits a merchant of an ad. The visit may be to a brick and mortar store of the merchant and/or or to a virtual store of the merchant, such as to a merchant's website. The computerized advertising system 101 may be configured to receive this visit information, for example, from an ad recipient mobile device that is being used by the ad recipient during a visit to a brick and mortar store of the merchant, such as from the ad recipient mobile devices 103, 105, and/or 107. Although each ad recipient mobile device has thus far been described as both receiving ads and providing notifications of merchant visits, different devices may instead be used for each function.

The computerized advertising system 101 may be configured to bill each merchant for the ads of the merchant that it circulates to ad recipients based on any criteria, examples of which are described below. The computerized advertising system 101 may be configured to deliver each bill to the merchant computer system that is associated with the merchant, such as to the merchant computer system 109, 111, and/or 113. Although each merchant computer system has thus far been described as being used both in the creation of ads and the receipt of bills for those areas, different systems may instead be used for each function. The computerized advertising system 101 may in addition or instead be configured to cause a print out of each bill to be delivered to each merchant.

The various components illustrated in FIG. 1 may communicate with one another using any means, such as by using a network communication system that may include the Internet, a local area network, a wide area network, a wireless communication system, such as a wireless data, cellular, Wi-Fi, and/or Bluetooth communication system, or any combination of these.

Although only three ad recipient mobile devices and three merchant computer systems have been illustrated, a different number may be used instead, such as two, four, or any larger number of such devices and systems.

Various examples of the computerized advertising system 101 and the ad recipient mobile devices 103, 105, and 107, are now described. However, these are only examples. Other configurations may be used instead.

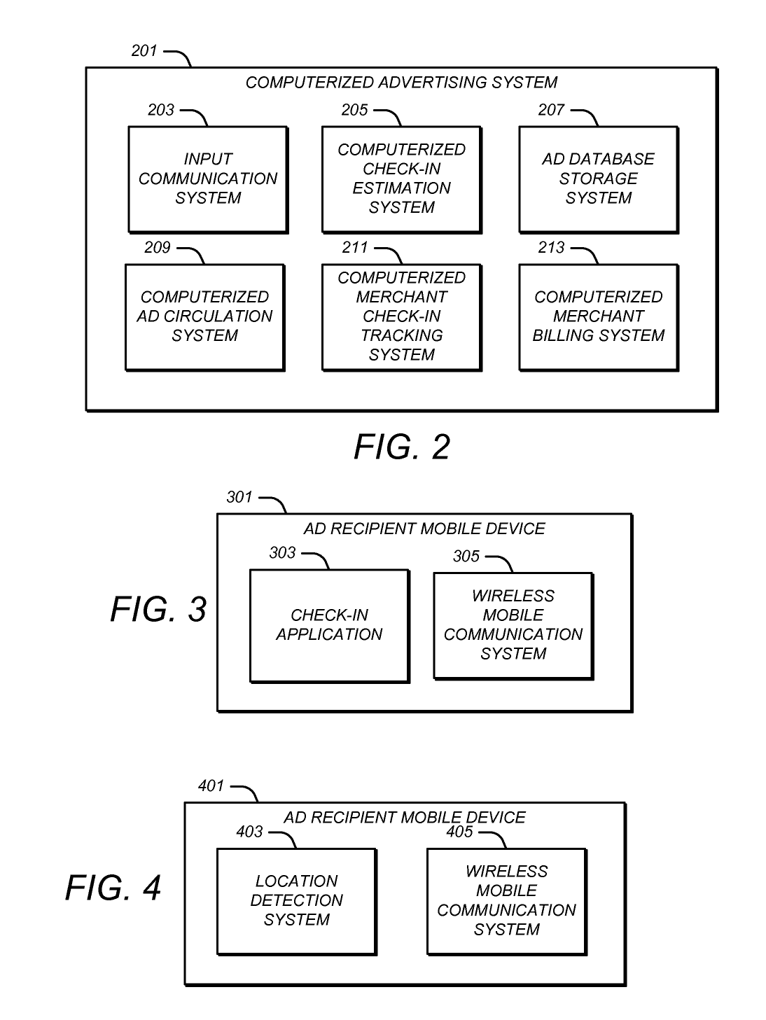

FIG. 2 illustrates an example of a computerized advertising system 201. The computerized advertising system 201 may be used as the computerized advertising system 101 illustrated in FIG. 1 or in a different type of network communication system. Similarly, the computerized advertising system 101 may be different from the computerized advertising system 201.

As illustrated in FIG. 2, the computerized advertising system 201 may include an input communication system 203, a computerized check-in estimation system 205, an ad database storage system 207, a computerized ad circulation system 209, a computerized merchant check-in tracking system 211, and a computerized merchant billing system 213.

The input communication system 203 may be configured to communicate with merchants or representatives of merchants, such as with the merchant computer systems 109, 111, and/or 113. The input communication system 203 may be configured to receive information and/or instructions from each merchant or representative concerning one or more ads for products or services that should be circulated to recipients, including ads for products or services marketed by the merchant. The information may include information indicative of all or portions of the content of each ad; information concerning the number and/or description (e.g., group(s) or class(es)) of recipients that should receive each ad; information concerning when each ad should be delivered to ad recipients (e.g., immediately, on a specified date, or when a specified event occurs); and/or information concerning a threshold number of ad recipients that the merchant would like to have visit a store or other location of the merchant as a result of the delivery of the ad to the ad recipients. The input communication system 203 may be configured to restrict the threshold number that may be entered for each ad, such as to restrict the lower end of each threshold, such as to 1, 5, 10, or 20, and/or the higher end of each threshold, such as to 20, 50, 100, 500, 1000, 5000, or 10,000. Examples of different types of information that the input communication system 203 may be configured to receive are described in more detail in the patent applications that have been Incorporated herein by reference.

The computerized check-in estimation system 205 may be configured to estimate, for each ad, how long it will take for a threshold number of recipients of the ad to visit the merchant of the ad, such as the threshold number received by the input communication system 203. The computerized check-in estimation system 205 may be configured to do so based on any information, such as based on the entered threshold for that ad, a determined number of recipients of that ad, and historical data indicative of how long it took a threshold number of recipients for each of one or more other ads to visit the merchants of those other ads.

The computerized check-in estimation system 205 may be configured to estimate how long it will take for a threshold number of recipients of the ad to visit a particular geographic location of the merchant of the ad based on historic data indicative of how long it took a threshold number of recipients of one or more other ads to visit the merchants of those other ads. For example, a first merchant may have a store in a first geographic region, and a second merchant may have a store in a second geographic region that is different from the first geographic region. In this example, the computerized check-in estimation system 205 may be configured to estimate how long it will take to reach the threshold for an ad for the first merchant's store based on historical data indicative of how long it took to reach the threshold for other ads for stores in the first region. Similarly, the computerized check-in estimation system 205 may be configured to estimate how long it will take to reach the threshold for an ad for the second merchant's store based on historical data indicative of how long it took to reach the thresholds for other ads for stores in the second region.

The input communication system 203 may be configured to communicate to the merchant computer system the time estimated by the computerized check-in estimation system 205 for an entered threshold to be reached, the amount the merchant will be charged for each visit, and the total cost of the ad program (i.e., the threshold x cost per visit). The input communication system 203 may be configured to then allow the entered threshold and/or description of ad recipients to be adjusted by the merchant computer system. The computerized check-in estimation system 205 may be configured to then again estimate how long it will take for the last entered threshold and description of recipients to visit the location of the merchant based on any of the criteria discussed above, as well as the total cost of the ad program. The revised estimate and cost may then again be presented back to the merchant computer system, following which further revisions to the threshold and/or recipients description may be made. This process may continue until a threshold and/or description of recipients are selected that yield a desirable estimated time and overall ad program cost.

The ad database storage system 207 may be configured to store information concerning the ads, such as the information received by the input communication system 203, such as the content of each ad, the class or classes of recipients that should receive each ad, when each ad should be delivered to the ad recipients, and the threshold number of ad recipients that the merchant would like to have visit a store or other location of the merchant as a result of the delivery of the ad to the ad recipients.

The computerized ad circulation system 209 may be configured to cause the ads to be delivered to recipients in accordance with the information that was received about them by the input communication system 203 and/or the information about them that is stored in the ad database storage system 207. For example, if a class of recipients was specified for a particular ad, the computerized ad circulation system 209 may be configured to deliver the ad to just that class of recipients. Similarly, if a time for delivery was specified for a particular ad, the computerized ad circulation system 209 may be configured to deliver the ad to the specified recipients at that time.

In some cases, an ad about a particular type of product or service may only be delivered by the computerized ad circulation system 209 to recipients that have manifested an interest in that type of product or service, as indicated in preferences previously specified by the recipients, preferences that have been determined about the recipients based on historic activity, and/or any other means. Examples of such preferences and systems that solicit, receive, and/or determine them are described in the provisional applications that are incorporated herein by reference.

The computerized merchant check-in tracking system 211 may be configured to receive check-in information indicative of when each recipient visits each merchant, such as when each recipient visits a brick-and-mortar and/or virtual website store of each merchant. The check-information may include information indicative of the identity of each visiting recipient and/or the street address, geographic coordinates, merchant code, and/or merchant name of the merchant that is visited. The computerized merchant check-in tracking system 211 may be configured to determine which recipients have visited which merchants based on this information. For example, the computerized merchant check-in tracking system 211 may be configured to determine whether a merchant is at a received street address, at received geographic coordinates, and/or which merchant is indicated by a received merchant code. The computerized merchant check-in tracking system 211 may be configured to do so by comparing this information with known street addresses, geographic coordinates, and/or codes of the various merchants.

The computerized merchant billing system 213 may be configured to bill a merchant of each ad based on the number of recipients of the ad that visit a brick and mortar and/or virtual store of the merchant. The computerized merchant billing system 213 may be configured not to increase the amount that is billed for each ad after the number of recipients of the ad that visit the merchant of the ad exceeds a threshold. That threshold, for example, may be one that is specified by the merchant computer system that communicated with the input communication system 203 and is stored in the ad database storage system 207.

The computerized merchant billing system 213 may be configured for each ad not to increase the amount that is billed to the merchant of that ad when a recipient of the ad visits the merchant more than once. For example, the computerized merchant billing system 213 may be configured for each ad not to increase the amount that is billed to the merchant of that ad when a recipient of the ad visits the merchant more than once within a pre-determined period, but to increase the amount that is billed to the merchant of the ad when the recipient of the ad visits the merchant both within and after the pre-determined period. The pre-determined may be in any amount, such as 12, 24, or 48 hours.

The computerized merchant billing system 213 may be configured for each ad not to bill the merchant of that ad based on the number of recipients of that ad that do not visit the merchant of the ad. Similarly, the computerized merchant billing system 213 may be configured for each ad to bill the merchant of the ad in an amount that does not depend upon whether any recipient of the ad makes any purchase from that merchant.

The computerized merchant billing system 213 may be configured for each ad to bill the merchant of the ad a fixed fee for each recipient that receives the ad and visits the merchant of the ad. The fixed fee may be based on the size of the ad, the number of recipients of the ad, the geographic location(s) of the recipients of the ad, and/or any other criteria.

FIG. 3 illustrates an example of an ad recipient mobile device 301 that includes a check-in application 303 and a wireless mobile communication system 305. Each ad recipient mobile device 103, 105, and/or 107 may be the same as or different from the ad recipient mobile device 301. Similarly, the ad recipient mobile device 301 may be used in a network communication system that is different from the one illustrated in FIG. 1.

The wireless mobile communication system 305 may be configured to communicate wirelessly with the computerized advertising system 101 using any type of wireless mobile communication system, such as a cellular network, a data network, a Wi-Fi system, and/or a Bluetooth system.

The check-in application 303 may be configured to allow a user of the ad recipient mobile device 301 to manually communicate to the input communication system 203 of the computerized advertising system 201 using the wireless mobile communication system 305 at each of such times as the user has arrived at a brick-and-mortar merchant store. The check-in application 303 may be configured to allow the user to manually enter or select the name of the merchant and/or the location of the merchant store, following which this information may be provided by the wireless mobile communication system 305 to the input communication system 203. The check-in application 303 may be configured to provide coupons or other inducements to the user of the ad recipient mobile device 301 upon arrival at a merchant. Other examples of the check-in application 303 are described in the patent applications that are incorporated herein by reference.

FIG. 4 illustrates an example of an ad recipient mobile device 401 that includes a location detection system 403 and a wireless mobile communication system 405. The wireless mobile communication system 405 may be the same as any of the types of wireless mobile communication systems 305 discussed above. The location detection system 403 may be configured to generate reports of the geographic coordinates of the ad recipient mobile device 401. These reports may be generated periodically when the ad recipient mobile device 401 is in motion, when directed by a user of the ad recipient mobile device 401, and/or on any other basis. To facilitate this functionality, the location detection system 403 may include a GPS receiver, a cell site triangulation system, a gyroscope, accelerometer, and/or any other type of location-sensing device.

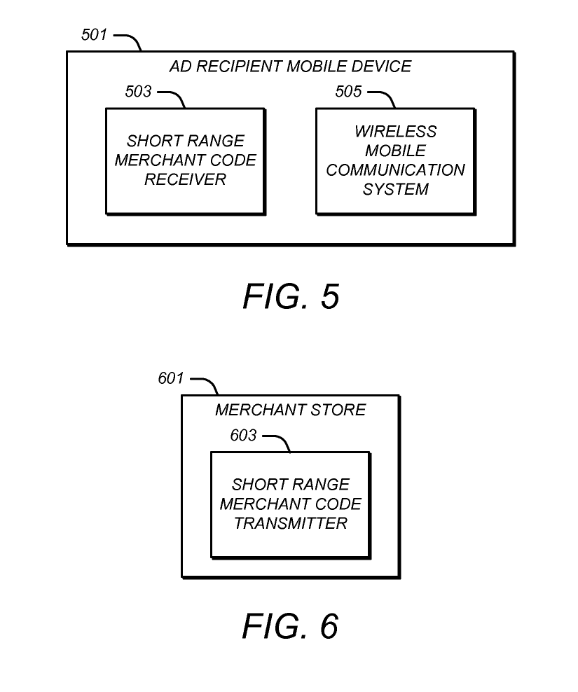

FIG. 5 illustrates an example of an ad recipient mobile device 501 that includes a short range merchant code receiver 503 and a wireless mobile communication system 505. The wireless mobile communication system 505 may be the same as any of the types of wireless mobile communication systems 305 discussed above. The short range merchant code receiver 503 may be configured to receive a merchant code from a short range merchant code transmitter located on the premises of the merchant and to deliver that code using the wireless mobile communication system 505 to the input communication system 203. The short range merchant code receiver may be configured to receive the merchant code using any means, such as Bluetooth and/or a near field communication protocol. The short range merchant code receiver 503 may be configured to automatically receive and retransmit the merchant code and/or to do so when manually requested by a user of the ad recipient mobile device 501.

FIG. 6 illustrates an example of a merchant store 601 that includes a short range merchant code transmitter 603. The short range merchant code transmitter 603 may be configured to wirelessly transmit a code that is uniquely indicative of the merchant's store to a corresponding short range merchant code receiver, such as to the short range merchant code receiver 503. The short range merchant code transmitter 603 may utilize any means to facilitate this transmission, such as Bluetooth and/or a near field communication protocol.

The computerized advertising system 101, the check-in application 303, the location detection system 403, and/or the short range merchant code receiver 503 may be part of any of the versions of the Elephanti system that is described in the patent applications that have been incorporated herein by reference.

Except as otherwise indicated, each ad recipient mobile device, computerized advertising system, and merchant computer system, as well as their respective subcomponents, are implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each ad recipient mobile device may be a portable computer, such as a laptop computer, a notebook computer, a tablet computer, a PDA, or a smartphone, or part of a larger system, such a vehicle.

Each computerized advertising system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A computerized advertising system comprising:
an input communication system configured to receive information indicative of one or more ads, each for a product or service marketed by a merchant;
an ad database storage system configured to store information indicative of the ads;
a computerized ad circulation system configured to controllably cause the ads to be delivered to recipients;
a computerized merchant check-in tracking system configured to receive check-in information indicative of when each recipient visits each merchant; and
a computerized merchant billing system configured to bill the merchant of each ad based on the number of recipients of the ad that visit the merchant.

2. The computerized advertising system of claim 1 wherein the computerized merchant billing system is configured not to increase the amount that is billed for each ad after the number of recipients of the ad that visit the merchant of the ad exceeds a threshold.

3. The computerized advertising system of claim 2 wherein:
the input communication system is configured to receive the threshold for each ad; and
the ad database storage system is configured to store each received threshold.

4. The computerized advertising system of claim 3 wherein the input communication system is configured to restrict the value of each threshold that the input communication system is configured to receive.

5. The computerized advertising system of claim 3 further comprising a computerized check-in estimation system configured to estimate for each ad how long it will take for the threshold number of recipients of the ad to visit the merchant of the ad.

6. The computerized advertising system of claim 5 wherein the computerized check-in estimation system is configured to estimate for each ad how long it will take to reach the threshold for the ad based on the threshold for the ad.

7. The computerized advertising system of claim 6 wherein the computerized check-in estimation system is configured to estimate for each ad how long it will take to reach the threshold for the ad based on the number of recipients of the ad.

8. The computerized advertising system of claim 7 wherein the computerized check-in estimation system is configured to estimate for each ad how long it will take to reach the threshold for the ad based on historical data indicative of how long it took a threshold number of recipients of one or more other ads to visit the merchants of those other ads.

9. The computerized advertising system of claim 8 wherein:
a first of the merchants has a store in a first geographic region;
a second of the merchants has a store in a second geographic region that is different from the first geographic region; and
the computerized check-in estimation system is configured to estimate how long it will take to reach the threshold for:
an ad for the first merchant's store based on historical data indicative of how long it took to reach the respective thresholds for other ads for stores in the first region; and
an ad for the second merchant's store based on historical data indicative of how long it took to reach the respective thresholds for other ads for stores in the second region.

10. The computerized advertising system of claim 1 wherein the computerized merchant billing system is configured for each ad not to increase the amount that is billed to the merchant of that ad when a recipient of the ad visits the merchant more than once.

11. The computerized advertising system of claim 10 wherein the computerized merchant billing system is configured for each ad not to increase the amount that is billed to the merchant of that ad when a recipient of the ad visits the merchant more than once within a pre-determined period, but to increase the amount that is billed to the merchant of that ad when the recipient of the ad visits the merchant both within and after the pre-determined period.

12. The computerized advertising system of claim 11 wherein the pre-determined period is 24 hours.

13. The computerized advertising system of claim 1 wherein the computerized merchant billing system is configured for each ad not to bill the merchant of that ad based on the number of recipients of that ad that do not visit the merchant of the ad.

14. The computerized advertising system of claim 1 wherein the computerized merchant billing system is configured for each ad to bill the merchant of the ad in an amount that does not depend upon whether any recipient of the ad makes any purchase from that merchant.

15. The computerized advertising system of claim 1 wherein:
the input communication system is configured to receive circulation information indicative of a class of recipients to whom each ad is to be delivered;
the ad database storage system is configured to store the circulation information; and
the computerized ad circulation system is configured to cause each ad to be delivered to the class of recipients indicated by its circulation information.

16. The computerized advertising system of claim 1 wherein the computerized merchant check-in tracking system is configured to receive the check-in information from a wireless mobile device that is carried by each recipient.

17. The computerized advertising system of claim 16 wherein:
the check-in information includes reports of the geographic coordinates of each wireless mobile device; and
the computerized merchant check-in tracking system is configured to determine whether each recipient has visited a merchant by comparing the geographic coordinates with known geographic coordinates of each merchant.

18. The computerized advertising system of claim 16 wherein:
the check-in information includes a code that each wireless mobile communication device receives from a short range code transmitter at a merchant store; and
the computerized merchant check-in tracking system is configured to determine whether each recipient has visited a merchant by comparing each received code with a known code for each merchant.

19. The computerized advertising system of claim 1 wherein the:
the input communication system is configured to receive delivery information indicative of when each ad should be delivered;
the ad database storage system is configured to store the delivery information; and
the computerized ad circulation system is configured to cause each ad to be delivered to recipients in accordance with the delivery information.

20. The computerized advertising system of claim 1 wherein the computerized merchant billing system is configured for each ad to bill each merchant of the ad a fix fee for each recipient that receives the ad and visits the merchant of the ad.

21. The computerized advertising system of claim 20 wherein the amount of the fix fee for each ad is based on the size of that ad.

22. The computerized advertising system of claim 20 wherein the amount of the fix fee for each ad is based on the geographic area in which the recipients of that ad are located.

23. A computerized advertising system comprising:
a computerized ad circulation system configured to controllably cause ads, each for a product or service marketed by a merchant, to be delivered to recipients;
a computerized merchant check-in tracking system configured to receive check-in information indicative of when each recipient visits each merchant; and
a computerized merchant billing system configured to bill the merchant of each ad based on the number of recipients of the ad that visit the merchant.
